(19) United States
(12) Patent Application Publication
(10) Pub. No.: US 2003/0226727 A1
(43) Pub. Date: Dec. 11, 2003

(54) Electric parking brake device

(76) Inventor: Daniel Laurent, La Suisse (CH)

Correspondence Address: BAKER & BOTTS, 30 ROCKEFELLER PLAZA, NEW YORK, NY, 10112

(21) Appl. No.: 10/424,417

(22) Filed: Apr. 28, 2003

(30) Foreign Application Priority Data
May 3, 2002 (FR) 02/05663

(51) Int. Cl. F16D 69/00

(52) U.S. Cl. 188/265

(57) ABSTRACT

An electric parking brake device for a vehicle at least two of whose wheels on the same axle are steered wheels whose steering angle is imposed selectively on each steered wheel by a dedicated electric actuator, each electric actuator being controlled by a direction control unit which determines a steering angle for each of the steered wheels as a function of at least one signal delivered by a vehicle path control element. A parking brake control unit delivers a parking brake locking command to the control unit, such that, upon receipt of a parking brake locking command, the control unit transmits antagonistic steering angle commands to the two wheels on the same axle.

### BACKGROUND OF THE INVENTION

1. The Field of the Invention

The present invention relates to parking brakes for automobile road vehicles.

2. The Related Art

In the present state of the art, means are developed increasingly for the electrical control of all actuators in a road vehicle, and in particular its steering. This technology is known as “steer by wire”. It consists in replacing the mechanical drive, whether assisted or not, between the steering wheel and the steered wheels by an electrical control chain involving no mechanical link between the steering wheel and the steered wheels.

The advantage of this technology is that it is ideally matched to advances in electronics, which allow increasingly sophisticated control concepts and enable the steering of the wheels to be placed not only under manual control but also under the control of a safety system and/or a system which optimizes the vehicle dynamics. Thus, for example, an angle can be imposed on the steered wheels which not only takes into account the control exercised by the vehicle's driver, but also takes into account dynamic parameters observed automatically on the vehicle.

In order to install an emergency function that compensates for failure of the main brake and that is capable of slowing the vehicle by steering the wheels on a given same axle in directions opposite to one another, European patent application EP 1 125 826 (U.S. patent application publications Ser. Nos. US 2001/0,032,748 A1 and US 2002/0,189,889 A1) proposes to use a system for controlling the individual steering of a vehicle's wheels by electrical means. However, this type of emergency braking risks creating handling problems for vehicles on ground or road surfaces that are not uniformly flat and/or on which the tire grip is not uniform.

### SUMMARY OF THE INVENTION

The present invention proposes to take advantage of the existence of individual actuators, for example electric actuators, which are capable of selectively steering each of the steered wheels in order to implement a parking brake which is designed to be actuated only when the vehicle is at rest.

The invention proposes a parking brake for a road vehicle at least two of whose wheels on the same axle are steered wheels whose steering angle is imposed selectively on each of the steered wheels by a dedicated actuator. Each actuator is controlled by a direction control unit which, for each steered wheel, determines a steering angle as a function of at least one signal delivered by a vehicle path control element. In accordance with the invention, the control element comprises a parking brake control element which delivers a parking brake locking command to the control unit. Upon receipt of a parking brake locking command, the control unit transmits to at least one steered wheel a steering command so as to create a displacement incompatibility.

The displacement incompatibility is produced, for example, by steering just one wheel of a four-wheeled vehicle, regardless of which wheel. In the case of a three-wheeled vehicle with two wheels on the same axle, steering only one of the wheels on the axle produces the displacement incompatibility, for example. Additional examples are given in more detail below. Those familiar with the field, however, will very easily be able to produce this displacement incompatibility by appropriate steering of the wheels, and will understand that the immobilization is more complete or less so depending on the steering configuration.

This makes it possible to obtain a parking brake without fitting any mechanical components dedicated to that function on the wheels or connected to the brake discs or brake shoes. The elements to be installed are any type of control means, for example a control knob, with appropriate programming in the direction control unit. The parking brake function is provided solely as described. This contributes towards keeping down the weight of the vehicle. Preferably, the actuation of this “parking brake” function is automatically made impossible as soon as the vehicle starts moving, for example above a very low speed threshold close to zero.

### BRIEF DESCRIPTION OF THE DRAWINGS

For a better understanding of the invention, reference may be made to the following description of exemplary embodiments thereof and to accompany drawings, in which:

FIG. 1 is a schematic view of an embodiment of a parking brake device in accordance with the invention installed on a vehicle with two steered wheels; and

FIG. 2 is a schematic view of another embodiment of a parking brake device installed on a vehicle with four steered wheels.

### DETAILED DESCRIPTION OF EXEMPLARY EMBODIMENTS

The control device of the invention described below illustrates a non-limiting application of the invention in which electric actuators are used to control the steering of the steered wheels of a four-wheel passenger car. Of course, other types of actuators could be used, for example hydraulic jacks or purely mechanical elements.

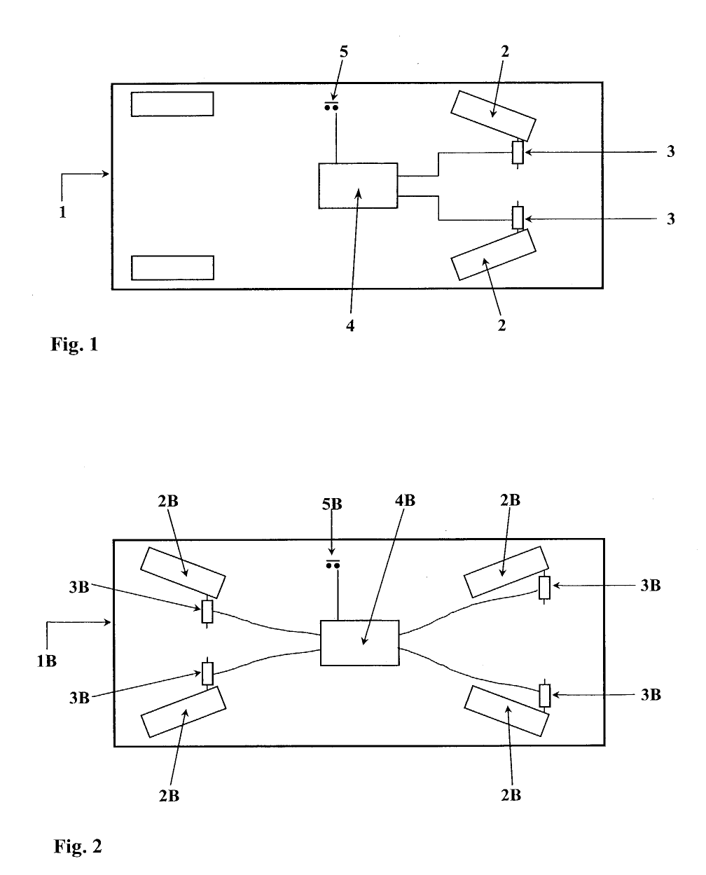

FIG. 1 shows a four-wheeled vehicle 1 whose front axle carries two steered wheels 2. Each steered wheel 2 is steered by an electric actuator 3 connected, on the one hand, to the body or chassis of the vehicle 1, and, on the other hand, to a wheel support (not shown) to control the steering angle of the wheel 2. A control unit 4 enables the steering of the steered wheels to be controlled as a function of various parameters, including of course a steering wheel or equivalent element. The control unit 4 is loaded with programs appropriate for the continuous computation of a suitable steering angle for each steered wheel, and controls the electric actuator 3 of each steered wheel 2. Examples of such programs and the structure and operation of the actuator 3 and the conrol unit 4 are within the skill of the man of ordinary skill in the art and, therefore, are not further described here..

A control knob 5 is provided for the parking brake of the vehicle. When the control knob 5 is turned to the “parking” position, the control unit 4 ignores the various parameters. It shifts from a “drive” mode to a “parking” mode and transmits to the electric actuators 3 commands that impose antagonistic steering angles for each of the two wheels on the same axle. For example, the control unit 4 steers the left front wheel to its maximum steering angle to the right, and steers the right front wheel to its maximum steering angle to the left. The vehicle adopts the configuration shown in FIG. 1. When the control knob 5 is turned to the “normal drive” position, the control unit 4 returns to the mode of operation in which it controls the steering of the steered wheels as a function of various parameters, including, of course, a steering wheel or equivalent element.

FIG. 2 shows a vehicle 1B with four wheels 2B mounted on two axles, all of the wheels 2B being steered wheels. In an analogous way, each steered wheel 2B is steered by an electric actuator 3B. A control unit 4B enables the steering of all the wheels. A parking brake control knob 5B is provided. When the control knob 5B is turned to the “parking” position, the control unit 4B transmits to the electric actuators 3B steering angle commands specific to the parking position, for example at least two antagonistic values on at least one axle.

Preferably, the control unit 4B transmits antagonistic steering angle commands to each of the two wheels 2B of both axles. In this case, it is advantageous for the steering commands to each of the wheels on the same side of the vehicle to be antagonistic. The vehicle's immobilization is still better if the control unit 4B steers the left front wheel to its maximum steering angle to the left, the right front wheel to is maximum steering angle to the right, the left rear wheel to its maximum angle to the right and the right rear wheel to its maximum angle to the left. The vehicle then has the configuration shown in FIG. 2.

In another advantageous way to produce displacement incompatibility in a four-wheeled vehicle all of whose wheels are steered, which is very useful for parking alongside a pavement, upon receipt of a parking brake command the control unit transmits to the wheels on one side, the side opposite the pavement, steering commands for example in opposite directions, while leaving the wheels on the other side aligned and so alongside the pavement.

As a variant, the parking brake control knob 5 can be replaced by an automatic device which, when it detects a situation in which the vehicle should be immobilized, for example when the vehicle's speed has remained zero for a predetermined time or when the driver switches off the vehicle, transmits to the control unit a command to actuate the parking brake. Conversely, when the automatic device detects a situation in which the vehicle should no longer be immobilized, for example when the driver accelerates, it transmits to the control unit a command to release the parking brake. Of course, the release can be progressive and, for example, correlated with the acceleration called for.

It should also be stressed that the parking brake device according to the invention at the same time provides an effective anti-theft function, since its release clearly requires authorization of the vehicle's actuation; for example, possession of its ignition key.

Although the invention has been described herein by reference to specific embodiments thereof, it will be understood that such embodiments are susceptible of modification and variation without departing from the inventive concepts disclosed. All such modifications and variations, therefore, are intended to be encompassed within the spirit and scope of the appended claims.

What is claimed is:

1. A parking brake device for a road vehicle at least two of whose wheels on the same axle are steered wheels whose steering angle is imposed selectively on each of the steered wheels by a dedicated actuator, each actuator being controlled by a direction control unit which determines for each of the steered wheels a steering angle as a function of at least one signal delivered by a vehicle path control element, wherein the parking brake device comprises a parking brake control element which transmits a parking brake locking command to the control unit; said control unit being operative, upon receipt of a parking brake locking command, to transmit to the actuator for at least one steered wheel a steering command such that a displacement incompatibility is produced.

2. A device according to claim 1, in which, upon receipt of a parking brake locking command, the control unit transmits to the respective actuators antagonistic steering angle commands for the two wheels on the same axle.

3. A device according to claim 1, for a vehicle with four steered wheels, in which, upon receipt of a parking brake command, the control unit transmits a steering command to the respective actuators of the wheels on one side of the vehicle while leaving the wheels on the other side aligned.

4. A device according to claim 1, for a vehicle with four steered wheels on two axles, in which, upon receipt of a parking brake command, the control unit transmits antagonistic steering angle commands to the respective actuators of the two wheels on the two axles.

5. A device according to claim 4, in which, upon receipt of a parking brake command, the control unit transmits antagonistic steering angle commands to the respective actuators of the lateral wheels on the same side of the vehicle.

6. A device according to claim 5, in which, upon receipt of a parking brake command, the control unit steers the left front wheel to the maximum steering angle to the left, the right front-wheel to the maximum steering angle to the right, the left rear wheel to the maximum steering angle to the right, and the right rear wheel to the maximum steering angle to the left.

7. A device according to claim 1, in which the actuators are electrically driven.
